(19) United States
(12) Patent Application Publication
(10) Pub. No.: US 2019/0184386 A1
(43) Pub. Date: Jun. 20, 2019

(54) A WIRE FOR MANUFACTURING CATALYST GAUZES

(71) Applicant: UMICORE AG & CO. KG, Hanau-Wolfgang (DE)

(72) Inventors: Martin VOTSMEIER, Weinheim (DE); Dirk BORN, Beibergemünd (DE)

(73) Assignee: UMICORE AG & CO. KG, Hanau-Wolfgang (DE)

(21) Appl. No.: 16/329,361

(22) PCT Filed: Sep. 27, 2017
(86) PCT No.: PCT/EP2017/074465

§ 371 Date: Feb. 28, 2019

(30) Foreign Application Priority Data
Oct. 6, 2016 (EP) 16192645.6

(51) Int. Cl. B01J 35/06; B01J 23/42; B01J 35/02; C01B 21/26

(52) U.S. Cl. CPC B01J 35/06; C01B 21/265; B01J 35/023; B01J 23/42

(57) ABSTRACT

Wire for weaving or knitting a catalyst gauze, said wire being characterized in that it is a stranded wire comprising an assembly of n intertwined filaments, n being an integer with 2≤n≤8, wherein each of said filaments comprises Pt or a Pt alloy constituted of at least 50% by 5 weight of Pt, said filaments being twisted together over their length so that each of the filaments is wound to at least one other filament.

### FIELD OF INVENTION

The present patent application falls in the domain of catalyst gauzes (which can be denominated in the generic term gauze(s) in the present application).

More precisely, the present invention concerns a wire material to be used for manufacturing a catalyst gauze.

In particular, the present invention concerns a wire material for weaving or knitting (e.g. warp or flat-bed knitting) catalyst gauzes. Such a wire material is known as to be made of a single filament, generally having a diameter comprised between 0.05 and 0.110 mm; and is usually made of Pt or of a Pt-rich alloy and is therefore a Pt-based or a Pt-rich alloy-based wire.

In the framework of the present invention, a Pt-rich alloy is intended to mean an alloy with 50.0 wt % or more Pt. For instance, the twisted wire material according to the invention is made from an alloy with at least 75.0 wt % Pt.

### Background of Invention

Usually, at least one of the above-described wire is woven or knitted so as to fabric catalyst gauzes made from platinum or from an alloy of platinum with other precious metals as minor components.

The knitted or woven wire (or plurality of wires) has a predetermined length L which, depending on the knitting type, is usually defined so as to determine the mesh and the size of the gauzes.

These catalyst gauzes are usually used in a reactor for ammonia oxidation to NO, an intermediate step in the manufacture of nitric acid.

FIG. 1 shows a representation of a reactor that is catalytically oxidizing ammonia and uses a catalyst pack and getter gauzes (Pd-based gauzes) for collecting the Pt and Rh (and Pd) losses during the reaction. In this figure, the reaction zone 2 of the flow reactor 1, the catalyst pack 3, which comprises several superimposed catalyst gauzes (PtRh-based gauzes) 4 in series and downstream getter gauzes 5, is arranged in a plane perpendicular to the direction of flow.

The ammonia/atmospheric oxygen mixture 6 flows through the catalyst pack under atmospheric or increased pressure. Ignition of the gas mixture takes place in the entry region, and the combustion reaction yields nitrogen monoxide (NO) and water 7 involving the entire catalyst pack. The NO in the reaction gas mixture 7 flowing out, subsequently reacts with the excess atmospheric oxygen (or additional secondary oxygen/air) to yield NO₂ 8, which forms nitric acid with water in a downstream absorption 9. The product may be fed, for example, to fertilizer production.

During the ammonia to NO oxidation process, N₂O is produced as an undesired by-product (as depicted in FIG. 1). N₂O is considered as a very potent greenhouse gas, for which reason it is important to limit the production of N₂O during ammonia oxidation.

It is known from WO01/87771 that catalyst gauzes made from Pd or Pd-rich wire used downstream of a traditional Pt-based catalyst gauze is not only employed for collecting Rh and Pt lost occurring upstream in the process, but may also be used to reduce the amount of N₂O produced. This probably works by dissociation of N₂O molecules.

Such Pd-based catalyst gauzes are however mechanically relatively weak, which means that they can develop breaks during use, which will obviously cause a part of the N₂O to bypass the Pd-based catalyst gauze without contact with the catalytically active metal. In addition, during collection of Pt and Rh, the Pd surface is partially blocked, so N₂O decomposition is reduced. This effect increases with increased (cumulative) losses of Pt; Rh during the application process. For this reason, the N₂O level will increase during the period of use, so that such Pd-based catalyst gauzes have a limited technical life, and may even require the shutdown of an ammonia oxidation plant to replace the catalyst gauzes. It is therefore a matter of fact that, although (being mechanically strong enough so as to be) suitable for collecting Rh;Pt, it remains non-technically (and economically) viable to adapt such a getter gauze for catalysing N₂O.

Indeed, the Pd-based gauzes are suitable for getting Pt; Rh which are volatilized during catalysis of ammonia and, being provided downstream in the process; are expected to be less exposed to the ammonia flow. This is why these Pd-based gauze are not expected to have the same lifetime as the Pt; Rh-based gauzes. In another words, although a Pd-based gauze is sufficiently resistant for being used as a Pt; Rh getter; it cannot be employed as an additional NO catalyst without inherent constraints related to this unusual use that make this alternative not sustainable; for the reasons explained above.

There is therefore a need for an alternative to the prior art solution in order to improve the catalysis efficiency of the gauze, in particular, to decrease the N₂O selectivity in the ammonia→NO conversion reaction.

### SUMMARY OF INVENTION

The present invention aims to solve or reduce the abovementioned and other problems by providing a wire as above-described in the preamble characterized in that it is a twisted wire comprising an assembly of n intertwined filaments, n being an integer with 2≤n≤8, wherein each of said filaments comprises at least 50% by weight of Pt, said filaments being twisted together over their length so that each of the filaments is wound to at least one other filament.

Preferably, said wire consists of n intertwined filaments, n being an integer equal to 3 or 4, so that the wire according to the invention may comprise three or four filaments.

Preferably, the twisted wire is made of a material comprising at least an alloy with at least 50.0 wt % not more than 95.0 wt % Pt. Optionally, the twisted wire is made of a material comprising at least an alloy with at least 80.0 wt % not more than 95.0 wt % Pt. More preferably, the twisted wire material according to the invention is made from a Pt—Rh alloy with at least 90.0 wt % Pt and at least 5.0 wt % Rh.

In particular, each of said filaments comprise at least 90% by weight of Pt.

Optionally, each of said filaments comprise at least 5% by weight of Rh.

In the framework of the present invention, said twisted wire can be defined as an assembly of said n filaments (each of the filaments being preferably tubular).

In this assembly, the n filaments are secured together so that each of the filaments has at least a portion of a first outer surface that is at least partially contacting a second outer surface of at least one other filament.

In the context of the present invention, the twisted wire results from stranded filaments which are intertwined. Intertwining results here from filaments that are twisted together so as to provide the twisted wire.

In the twisted wire according to the present invention, each of said n filaments has its own reference diameter d_{f}, said reference diameter d_{f} being defined as a diameter of a circle having a circumference that is equal to an outer perimeter of a cross-sectional shape of an individual filament of said at least two filaments, said cross-sectional shape of said individual filament being a shape of the individual filament on a section plane that is perpendicular to a longitudinal axis of said individual filament.

The twisted wire according to the invention has a reference diameter d_{w} being defined as a diameter of a circle having a circumference that is equal to an outer perimeter of a cross-sectional shape of said twisted wire, said cross-sectional shape of the twisted wire being a shape of the twisted wire on a second section plane perpendicular to a longitudinal axis of said twisted wire.

Each filament of the twisted wire according to the invention has its own d_{f}; and the d_{f} values as well as the arrangement of the n filaments govern together the value of d_{w}.

When made of a woven or knitted twisted wire according to the present invention, the catalyst gauze presents a higher catalytic activity of the ammonia to NO conversion.

The increase of the catalytic activity of the gauze made of a woven or knitted twisted wire according to the present invention is ensured by a higher contact surface of said wire [S_{c}] per gauze surface [S_{g}] (ratio S_{c}:S_{g}).

Indeed, compared to a conventional gauze of a predetermined mesh value which is made of n independent single-filament wires (with 8≥n≥2), a gauze having the same mesh value but which is made of a twisted wire constituted of n filaments (with 8≥n≥2); provided that each of the single-filament wires and the filaments of the twisted wire according to the invention have at least identical active material composition [i.e. PGM material]; and optionally identical d_{f}; presents a higher S_{c}:S_{g} ratio.

In the framework of the present invention, the term mesh is used for defining an average separation distance between two neighbouring parts of wire(s) in a gauze. In such a context, two gauzes presenting the same mesh value are characterized by the same average separation distance between two neighbouring parts of wire(s); meaning that for a given surface, a gauze made with a twisted wire comprising n filaments presents a higher quantity of material than a gauze made of two individual single-filament wires, so that the density of material is increased in the gauze made of the twisted wire according to the invention.

In the framework of the present invention, a gauze having increased density can therefore be achieved because the filaments of the twisted wire are secured (intertwined) together.

Surprisingly, it has been observed that, despite an unavoidable shadowing, the assembly of filaments of the twisted wire according to the invention allows the gauze that is made of said twisted wire to have a sufficient S_{c}:S_{g} ratio so that the catalytic activity of the gauze is relatively improves versus a conventional gauze of 8≥n≥2 individual single-filament wires.

Shadowing is defined in the framework of the present invention as an area of (partial or full) overlap between at least two outer surfaces of the filaments (or parts of filaments) comprised in the twisted wire according to the invention. A gauze made of a twisted wire according to the invention presents this overlap area which is an inaccessible area for the ammonia to enter into contact with the material constituting said filaments.

Indeed, in the twisted wire according to the invention, said filaments overlap so that at least one first filament of said n filaments has a first outer surface that is facing or that is contacting at least partially a second outer surface of at least one second filament of the n filaments. Indeed outer surfaces of two filaments which are at least partially facing or contacting each other are more difficultly accessible by the ammonia gas.

A partial overlap implies that part(s) of the outer surfaces are overlapping.

A full overlap implies that the entire outer surface of at least one filament is overlapping with the outer surface of other filaments.

Also, it has been unexpectedly observed that, when the twisted wire comprising n filaments according to the present invention is employed to fabric a gauze, such a resulting gauze shows an increase of the NO selectivity (decrease of the N₂O selectivity) during catalysis.

Although not yet explained, the inventors believe that this increase in the NO selectivity is related to the combination of the improved S_{c}:S_{g} ratio and an improved twisted wire network/geometry, compared to a conventional gauze made of n single-filament wires and having the same composition and mesh value.

In contrast to what is normally observed or expected, assembling (intertwining) 2 to 8 filaments so as to have a twisted wire according to the invention remains technically attractive because the intrinsically increase of the pressure drop (expected with an increase of the wire diameter) is compensated by an improved geometry of at least a part of an outer (catalytic) surface of said twisted wire, said geometry being governed by the outer surface of each of the filaments constituting said twisted wire and allowing the flow gas of ammonia to remain longer in contact with said outer surface of the twisted wire, when contacting the gauze made of said twisted wire. The inventor believe that this longer residence time is correlated to the increase of the NO selectivity of the ammonia oxidation reaction.

In addition to the compensation of the increase of the pressure drop, the technical effect related to the use of a twisted wire according to the invention is therefore an improvement of the overall efficiency of the catalysis process.

The twisted wire according to the present invention, when used in a gauze, allows a noticeable improvement of the catalysis activity and the NO selectivity of the oxidation of the ammonia with said gauze; and the use of a Pd-based gauze downstream of the process becomes irrelevant for capturing N₂O formed during the process. In fact, Pd gauzes only reduce the already formed N₂O, and do not reduce the rate of primary formation which is the main effect resulting from the use of a twisted wire according to the invention. Use of a Pd-based gauze downstream in such a context is a major disadvantage versus a gauze made of a twisted wire of the present invention, mainly because N₂O decomposition products are not NO or NO₂, but N₂ and O₂. So NH₃, by using a Pd-based gauze according prior art leads to a less effective NH₃ to NO conversion.

Other details and advantages of the present invention will become apparent from the description hereunder of preferred and non-limitative embodiments of the invention:

### Embodiment 1

In a first embodiment, the twisted wire according to the invention comprises n filaments, with n being an integer superior to 3 and inferior to 8. Preferably, 3≤n≤7. More preferably, 3≤n≤6. Most preferably, 3≤n≤5. Alternatively, 4≤n≤8 or 5≤n≤8, or even 6≤n≤8. n can also be equal to 3 or to 4, or even to 5. n can also be equal to 6, 7 or even 8.

In particular, said at least three (preferably tubular) filaments that are intertwined, i.e. twisted or spun together (wound to each other).

The twisted wire according to the invention therefore comprises at least three (preferably tubular) filaments which are twisted or spun together. Preferably, the wire according to the invention comprises n filaments, with n being an integer selected in the series of n=4, 5, 6, 7 or 8; which are twisted or spun together.

When the filaments are twisted or spun around each other, the twisted wire according to the invention presents a less uniform outer surface allowing an improved residence time of the ammonia in the gauze made of said wire.

### Embodiment 2

In a second embodiment of the invention, said filaments have its own reference diameter d_{f} inferior or equal to 0.100 mm and superior or equal to 0.010 mm, each first reference diameter d_{f} being defined as the diameter of a circle having the same area as the cross sectional area of the corresponding filament.

Optionally, 0.010 mm≤d_{f}≤0.150 mm; alternatively, 0.010 mm≤d_{f}≤0.100 mm; preferably 0.010 mm≤d_{f}≤0.075 mm; more preferably 0.010 mm≤d_{f}≤0.070 mm; most preferably 0.010 mm≤d_{f}≤0.065 mm; even more preferably 0.010 mm≤d_{f}≤0.060 mm. Optionally, 0.060 mm≤d_{f}≤0.065 mm.

If d_{f}>0.150 mm; the twisted wire diameter resulting from assembling n wires having said d_{f}>0.150 mm is too large for being technically advantageous, as an increase of the pressure drop during used of a gauze made of said wire.

### Embodiment 3

In a third embodiment of the invention, d_{w} does not exceed 0.300 mm. Optionally, d_{w} is superior or equal to 0.040 mm.

In particular, the wire according to the invention has a reference diameter d_{w} being defined as the diameter of a circle having the same area as the cross sectional area of the wire, with 0.040 mm≤d_{w}≤0.300 mm.

Preferably, 0.040+(e+f)≤d_{w}≤0.300−(g+h); or: 0.040+(e+f)≤d_{f} and d_{f}≤0.300−(g+h), where e and g are expressed in mm.

e can independently have the following value: 0; 0.010; 0.020; 0.030; 0.040; 0.050; 0.060; 0.070; 0.080; 0.090; 0.100; 0.110; 0.120; 0.130; 0.140; 0.150; 0.160; 0.170; 0.180; 0.190; 0.200; 0.220; 0.230; 0.240; or 0.250.

g can independently have the following value: 0; 0.010; 0.020; 0.030; 0.040; 0.050; 0.060; 0.070; 0.080; 0.090; 0.100; 0.110; 0.120; 0.130; 0.140; 0.150; 0.160; 0.170; 0.180; 0.190; 0.200; 0.220; 0.230; 0.240; or 0.250.

Also, e can be equal to g or e can be higher or lower than g.

f and h (which are expressed in mm) can independently have the following value: 0; 0.001; 0.002; 0.003; 0.004; 0.005; 0.006; 0.007; 0.008; 0.009; or 0.010. Also, f can be equal to h or f can be higher or lower than h.

Also, e can be equal to 0; 0.010; 0.020; 0.030; 0.040; 0.050; 0.060; 0.070; 0.080; 0.090; 0.100; 0.110; 0.120; 0.130; 0.140; 0.150; 0.160; 0.170; 0.180; 0.190; 0.200; 0.220; 0.230; 0.240; or 0.250.

Also, g can be equal to 0; 0.010; 0.020; 0.030; 0.040; 0.050; 0.060; 0.070; 0.080; 0.090; 0.100; 0.110; 0.120; 0.130; 0.140; 0.150; 0.160; 0.170; 0.180; 0.190; 0.200; 0.220; 0.230; 0.240; or 0.250.

Also, e can be equal to g or e can be higher or lower than g.

Also, f can be equal to 0; 0.001; 0.002; 0.003; 0.004; 0.005; 0.006; 0.007; 0.008; 0.009; or 0.010.

Also, h can be equal to 0; 0.001; 0.002; 0.003; 0.004; 0.005; 0.006; 0.007; 0.008; 0.009; or 0.010.

Also, f can be equal to h or f can be higher or lower than h.

More preferably, d_{w}=0.150 mm or 0.140 mm.

### Embodiment 4

In a fourth embodiment of the invention, d_{f} can be comprised in the following ranges (expressed in mm):
0.010 mm≤d_{f}≤0.140 mm;
0.010 mm≤d_{f}≤0.130 mm;
0.010 mm≤d_{f}≤0.120 mm;
0.010 mm≤d_{f}≤0.110 mm;
0.010 mm≤d_{f}≤0.115 mm;
0.010 mm≤d_{f}≤0.090 mm;
0.010 mm≤d_{f}≤0.080 mm;
0.010 mm≤d_{f}≤0.070 mm;
0.010 mm≤d_{f}≤0.060 mm;
0.040 mm≤d_{f}≤0.080 mm;
0.050 mm≤d_{f}≤0.075 mm;
0.055 mm≤d_{f}≤0.070 mm;
0.055 mm≤d_{f}≤0.065 mm;
0.055 mm≤d_{f}≤0.060 mm;
0.055 mm≤d_{f}≤0.150 mm;
0.060 mm≤d_{f}≤0.150 mm;
0.070 mm≤d_{f}≤0.150 mm;
0.080 mm≤d_{f}≤0.150 mm;
0.090 mm≤d_{f}≤0.150 mm;
0.100 mm≤d_{f}≤0.150 mm;
0.110 mm≤d_{f}≤0.150 mm;
0.120 mm≤d_{f}≤0.150 mm;
0.130 mm≤d_{f}≤0.150 mm;
0.140 mm≤d_{f}≤0.150 mm.

In such a case, the twisted wire according to the invention comprises n filaments, each of these n filaments having its own d_{f} value.

Optionally, each filament of the n filaments has its own d_{f} that can be adjusted so that, when said filaments are assembled together, d_{w} is preferably inferior or equal to 0.300 mm.

Preferably, each filament of the n filaments has its own d_{f} that can be adjusted so that, when said filaments are assembled together, d_{w} is superior or equal to 0.040 mm.

### Embodiment 5

In a fifth embodiment of the invention, d_{f} can also be comprised in the following ranges (expressed in mm):

0.010+a≤d_{f}≤0.150−b;

where a and b (which are expressed in mm) can independently have the following value: 0; 0.010; 0.020; 0.030; 0.040; 0.050; 0.060; 0.070; 0.080; 0.090; 0.100; 0, 110; 0.120; 0.130; or 0.140.

Also, a can be equal to 0; 0.010; 0.020; 0.030; 0.040; 0.050; 0.060; 0.070; 0.080; 0.090; 0.100; 0.110; 0.120; 0.130; or 0.140.

Also, b can be equal to 0; 0.010; 0.020; 0.030; 0.040; 0.050; 0.060; 0.070; 0.080; 0.090; 0.100; 0.110; 0.120; 0.130; or 0.140.

In such Embodiment 5, the twisted wire according to the invention comprises n filaments, each of these n filaments having its own d_{f} value.

Optionally, each filament of the n filaments has its own d_{f} that can be adjusted so that, when said filaments are assembled together, d_{w} is preferably inferior or equal to 0.300 mm.

Preferably, each filament of the n filaments has its own d_{f} that can be adjusted so that, when said filaments are assembled together, d_{w} is superior or equal to 0.040 mm.

Also, a can be equal to b or a can be higher or lower than b.

Also, c can be equal to d or c can be higher or lower than d.

For instance a can be equal to 0.010 and b can be equal to 0.020; or a and b maybe equal to 0.010; etc.

Preferably, 0.010+(a+c)≤d_{f}≤0.150−(b+d); or: 0.010+(a+c)≤d_{f} and d_{f}≤0.150−(b+d).

where a and b (are expressed in mm) can independently have the following value: 0; 0.010; 0.020; 0.030; 0.040; 0.050; 0.060; 0.070; 0.080; 0.090; 0.100; 0.110; 0.120; or 0.130, and where c and d (which are expressed in mm) can independently have the following value: 0; 0.001; 0.002; 0.003; 0.004; 0.005; 0.006; 0.007; 0.008; 0.009; or 0.010.

Also, a can be equal to 0; 0.010; 0.020; 0.030; 0.040; 0.050; 0.060; 0.070; 0.080; 0.090; 0.100; 0.110; 0.120; or 0.130.

Also, b can be equal to 0; 0.010; 0.020; 0.030; 0.040; 0.050; 0.060; 0.070; 0.080; 0.090; 0.100; 0.110; 0.120; or 0.130.

Also, c can be equal to 0; 0.001; 0.002; 0.003; 0.004; 0.005; 0.006; 0.007; 0.008; 0.009; or 0.010.

Also, d can be equal to 0; 0.001; 0.002; 0.003; 0.004; 0.005; 0.006; 0.007; 0.008; 0.009; or 0.010.

Also, a can be equal to b or a can be higher or lower than b.

Also, c can be equal to d or c can be higher or lower than d.

In such a preferred embodiment of Embodiment 5, the twisted wire according to the invention comprises n filaments, each of these n filaments having its own d_{f} value.

In such a preferred embodiment of Embodiment 5, each filament of the n filaments has its own d_{f} that can be adjusted so that, when said filaments are assembled together, d_{w} is preferably inferior or equal to 0.300 mm.

Preferably, each filament of the n filaments has its own d_{f} that can be adjusted so that, when said filaments are assembled together, d_{w} is superior or equal to 0.040 mm.

Each of the individual Embodiments 1 to 5 described hereabove can be combined with one or more of the product embodiments described before it.

Also, the invention concerns a catalytic or catalyst gauze for the catalytic oxidation of ammonia into NO that comprises or is made, at least partially, of the twisted wire according to the invention.

Viewed from a third aspect, the invention also covers an installation for the catalytic oxidation of ammonia to NO, comprising at least one catalyst gauze according to the invention.

Equivalently, the invention covers a use of the gauze according to the invention in an installation for the catalytic oxidation of ammonia to NO.

### BRIEF DESCRIPTION OF THE FIGURES

In order to explain the invention a non-limiting example of a specific embodiment of a catalyst gauze according to the invention and its use is given below, with reference to the following figures:

FIGS. 2a and 2b, which show two magnified microscopic images (a-left and b-right), acquired from two different views, of a twisted wire according to the invention comprising four filaments which are twisted together over their length so that each of the filaments is wound to at least one other filament, resulting into a yarn wire. Each of the filaments is a cord and has a diameter of 0.060 mm. The composition of each of the filaments is PtRh5 [95.0 wt % Pt+5.0 wt % Rh], and

FIGS. 3i and 3ii, which depict: i)-left: a 2D structure of a catalyst gauze made of the twisted wire of FIG. 1; and ii)-right: a 2D structure of a catalyst gauze made of two single-filament wires, each of the wires having a diameter of 0.076 mm and a composition that is similar to the composition of the filaments constituting the wire of FIG. 1 (PtRh5). Gauzes i) and ii) have been knitted with the same pattern (identical knitting types).

### DETAILED DESCRIPTION

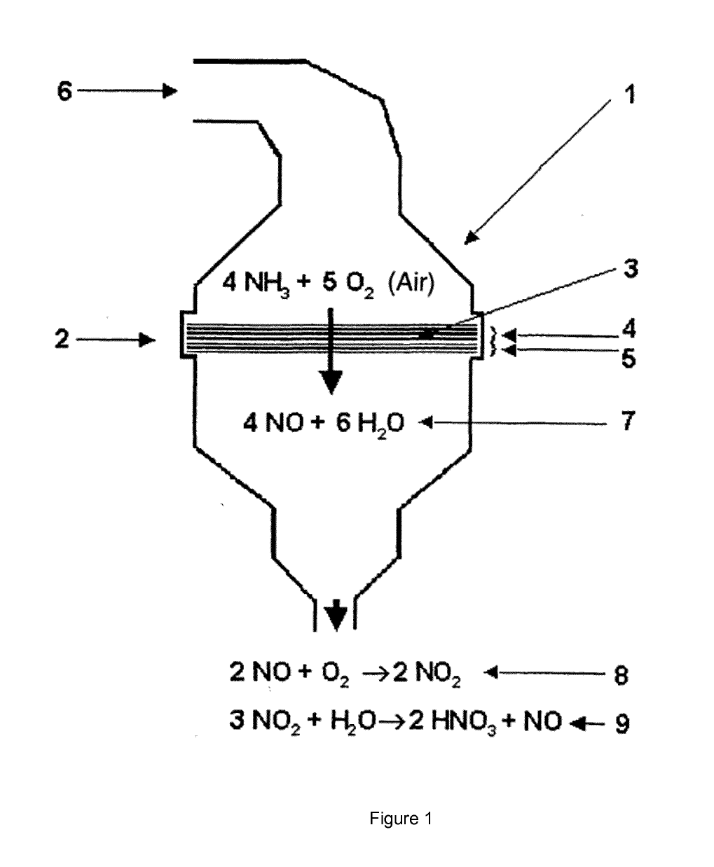

The twisted wire according to the invention which is depicted in FIGS. 2a and 2b is a yarn wire comprising four filaments, these filaments are preferably tubular.

Each of these filament is a cord (tubular-shaped) characterized by a first reference diameter d_{f} of +/−0.060 mm±0.003 mm. These filaments are twisted so as to provide a twisted wire having a second reference diameter d_{f} of +/−0.140 mm±0.003 mm.

Diameter where measured with conventional LAZER-based technology inspired of the well-known Modular Laser Measuring Head for Diameter, Width, Height principle.

In the context of the present invention, d_{w} and d_{f} are expressed in mm, and values of d_{w} and d_{f} expressed as 0,(0)ₘ X_{[i1,il]}, where X_{[i1, ii}]=Xᵢ₁Xᵢ₂ . . . Xᵢᵢ, with m and X being an integer; and X>0, which is equivalent to a following alternative expression: X 10^{-(m+Σ(ii))}; where 10^{-(m+Σ(ii))} is a factor for designating a m+Σ(il) decimal multiples (and submultiples) of X.Σ(il)=I. For instance if X=15, Xᵢ₁=1; and Xᵢ₂=5, and Σ(il)=Σ(i2)=2

Alternatively, a value expressed as 0,(0)ₘ X_{[i1,il]} is equivalent to a value expressed as 0.(0)ₘ X_{[i1,ii]}.

For instance, a value of 0.010 is equivalent to 0.010.

In said value of 0.010; m=1 and: Xᵢ₁=1; so that Σ(il)=1, and is further equivalent to 1 10⁻⁽¹⁺¹⁾=1 10⁻².

In another example, a value of 0.015 is equivalent to 0.015.

In said value of 0.015; m=1 and: Xᵢ₁=1; and Xᵢ₂=5; so that Σ(il)=Σ(i2)=1+1=2. Therefore, 0.015=15 10⁻⁽¹⁺²⁾=15 10⁻³.

In another example, a value of 0.150 is equivalent to 0.150.

In said value of 0.150; m=0 and: Xᵢ₁=1; Xᵢ₂=5; so that Σ(il)=Σ(i2)=2, and is further equivalent to 1 10⁻⁽⁰⁺¹⁺¹⁾=1 10⁻².

In the assembly of FIGS. 2a and 2b, each of the filaments has its outer surface contacting at least partially at least one other neighboring filament outer surface, so that shadowing regions are created in the wire.

An outer surface of filament is defined in the context of this invention by the following formula:
2πLd_{f};

with L being a predetermined length of the filament and d_{f} the reference diameter of the filament.

These shadowing regions correspond to parts of the outer surface of each filament that are unavailable for the catalysis reaction. These shadowed regions are not free and cannot be accessed by the ammonia gas when the wire is used in a gauze. On the opposite, an available (or free; or catalytic) outer surface of a filament is an outer surface that will be available for reacting with the ammonia gas.

As depicted in FIGS. 2a and 2b, each of the free outer surfaces (also considered here as the catalytic surface) of the filaments defines the catalytic surface of the wire according to the invention.

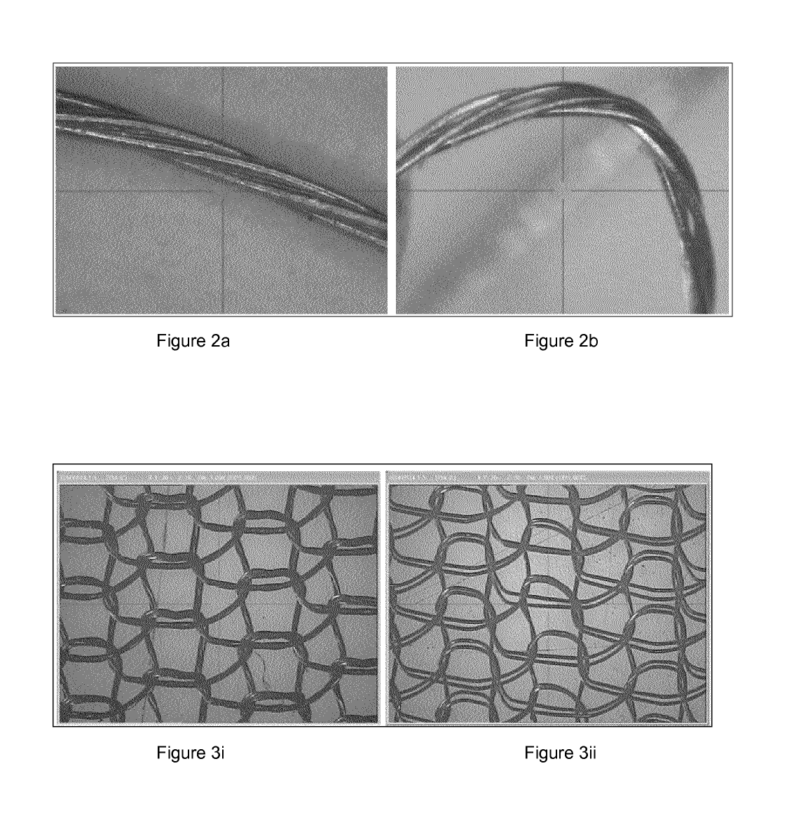

The catalyst gauzes 3i of FIG. 3i results from the knitting of the 4-filaments wire of FIG. 2a.

This wire was knitted on a flat-bed knitting machine into gauze 3i with a weight per square meter (m²) of 800 g/m². Gauze 3i type is called here Twisted type 01.

The catalyst gauze 3ii of FIG. 3ii was knitted under the same condition than for gauze 3i, but with two single-filament wires (see FIG. 2b) having a diameter of 0.076 mm.

Compositions of the two single-filament wires used for the gauze catalyst 3ii are the same than for the wire of gauze catalyst 3i. Gauze 3ii type is called here Platinit type 01.

Comparative Tests

The catalyst gauzes 3i and 3ii were tested for their catalytic properties as follows:

A test reactor was used with an effective diameter of 10.0 cm. In this test reactor, the following catalyst gauzes were installed (per test), in order:

Test 1: Measurement of the Twisted Type 01 Catalytic Gauze Properties

Bed of:
4 superimposed Twisted type 01 gauzes which have been superimposed;
4 superimposed standard knitted catalyst gauzes [Platinit type 01] made of 2 single-filament wires of 0.076 mm diameter of Pt+5 wt % Rh alloy with total weight of 800 g/m².

Test 2: Measurement of the Reference Platinit Type 01 Catalytic Gauze Properties

Bed of:
8 superimposed standard knitted catalyst gauzes [Platinit type 01] made of 2 single-filament wires of 0.076 mm diameter of Pt+5.0 wt % Rh alloy with total weight of 800 g/m²;

In test 2, the Platinit type 01 gauze is made of 2 single-filament wires. As illustrated in FIG. 3ii, the two filaments are not brought into intimate contact and are therefore present in a loose and isolated form. On the contrary, in test 1, the Twisted type 01 comprises filaments which are secured together and are not single-filaments like in the Platinit type 01 gauze.

Results

For tests 1 and 2, the bed of catalyst gauzes was heated to a temperature range: 870° C.-890° C. The reactor was operated at 3.6 or 5.0 bar absolute pressure.

A feed of approx. 4.76 kg/h NH₃ in the form of a 10.7 vol.-% (equals 6.7% w/w) NH₃ mixture in air was supplied to the bed of catalyst gauzes. The N₂O content was determined each day and after maximum 13 days on stream, and was as follows:

TABLE 1
Output results data from tests 1 and 2; including test parameters (pressure (bar),
temperature temp [° C.], load (in days), weight of ammonia (wt %); and post-ammonia
oxidation results: N₂O content (in ppm) in mixture and corresponding NO selectivity. The
nitrous oxide concentration in nitrous gases was determined by gas chromatography method.

| | | | | Type 01 twisted | | Type 01 standard | |
|---|---|---|---|---|---|---|---|
| load | pressure | temp | w_NH3 | Sel. [%] | N2O [ppm] | Sel. [%] | N2O [ppm] |
| 12 | 5 | 890 | 6.78 | 95.5 | 941 | 95.4 | 1048 |
| 12 | 5 | 890 | 6.72 | 95.6 | 935 | 95.2 | 1040 |
| 12 | 5 | 890 | 6.71 | 95.3 | 999 | 95.5 | 1091 |
| 12 | 5 | 890 | 6.72 | 95.9 | 1004 | 95.6 | 1099 |
| 8 | 5 | 870 | 6.75 | 95.6 | 1047 | 95.3 | 1057 |
| 8 | 5 | 890 | 6.7 | 95.4 | 814 | 95.2 | 849 |
| 8 | 5 | 890 | 6.74 | 95.3 | 861 | 95.3 | 909 |
| 8 | 5 | 890 | 6.72 | 95.7 | 858 | 95.4 | 889 |
| 8 | 5 | 870 | 6.77 | 95.4 | 1116 | 95.3 | 1150 |
| 8 | 5 | 870 | 6.76 | 95.4 | 1142 | 95.1 | 1167 |
| 15 | 5 | 890 | 6.7 | 95.9 | 1152 | 95.3 | 1255 |
| 15 | 5 | 890 | 6.67 | 95.6 | 1156 | 95.2 | 1184 |
| 15 | 5 | 890 | 6.71 | 95.8 | 1150 | 95.3 | 1268 |
| 15 | 5 | 890 | 6.65 | 95.8 | 1158 | 95.3 | 1274 |
| 12 | 3.6 | 870 | 6.66 | 95.5 | 1050 | 95.5 | 1160 |
| 12 | 3.6 | 870 | 6.73 | 95.7 | 1047 | 95.5 | 1147 |
| 12 | 5 | 870 | 6.65 | 95.7 | 1305 | 95.3 | 1411 |
| 12 | 5 | 870 | 6.66 | 95.7 | 1285 | 95.2 | 1387 |
| 12 | 5 | 890 | 6.68 | 96.1 | 1092 | 95.9 | 1170 |
| 12 | 3.6 | 870 | 6.72 | 96.1 | 1116 | 95.6 | 1188 |
| | | | mean value | 95.65 | 1061.40 | 95.37 | 1137.15 |

[symbol]

, where, w_NH3 = % w/w (NH3). [symbol]
, where reactors loads' indications [t N/(m²d)] a tolerance of +/− 0.05 t N/(m²d), where t is ton; N is Nitrogen (equivalent to ammonia: mol. N = 14/17 × mol. NH₃); m² is a surface unit parameter (surface of a cross section (perpendicular to the flow gas direction) of the reactor [for instance in FIG. 1, section →2 − 4←]; and d is 24 hours (a day). [symbol]
indicates data missing or illegible when filed

Pressure was stable during the operation time and was on the level of 5.0+/−0.02 bar absolute and 3.6+/−0.02 bar absolute, according to the test schedule.

The selectivity to NO of the oxidation reaction, determined as mean value after 13 days, was 0.28% [confidence interval=+/−0.097] higher by using a gauze made of the wire according to the invention; the N₂O level being decreased by 6.7%.

NO selectivity (S_{NO}) is provided by the following formula:

S_{NO}(in %)=(X2/X1)*100%;

where X1=ammonia concentration in ammonia-air mixture; and

where X2=concentration of oxidized ammonia (NO+NO₂), % w/w.

Although Table 1 provides 20 measurements, it must be understood that for some day of the 13-days measurement period, more than one load has been performed during this test period.

It is understood that the present invention is by no means limited to the forms of the above detailed description and that many modifications can be made without departing from the scope of the appended claims.

For instance, it must be understood that if the description discloses a wires made of 4 twisted or spun filaments, the scope of the present invention also covers a wire which may be made of n filaments, with n being an integer varying from 2 to 8, including these two values.

1. A wire for weaving or knitting a catalyst gauze, wherein said wire is a twisted wire comprising an assembly of n intertwined filaments, n being an integer with 2≤n≤8, wherein each of said filaments comprises at least 50% by weight of Pt, said filaments being twisted together over their length so that each of the filaments is wound to at least one other filament.

2. Wire according to claim 1, wherein 3≤n≤8.

3. Wire according to claim 1, wherein each of said filaments have its own reference diameter dr inferior or equal to 0.100 mm and superior or equal to 0.010 mm, each first reference diameter d_{f} being defined as the diameter of a circle having the same area as the cross sectional area of the corresponding filament.

4. Wire according to claim 3, wherein 0.010 mm≤d_{f}≤0.075 mm.

5. Wire according to claim 1, wherein said wire has a reference diameter d_{w} being defined as the diameter of a circle having the same area as the cross sectional area of the wire, with 0.040 mm≤d_{w}≤0.300 mm.

6. Wire according to claim 1, wherein it comprises at least four filaments

7. Wire according to claim 1, wherein each of said filaments comprise at least 90% by weight of Pt.

8. Wire according to claim 1, wherein each of said filaments comprise at least 5% by weight of Rh.

9. Wire according to claim 3, wherein d_{f}=0.060 mm.

10. A catalyst gauze made of the wire according to claim 1.

11. Use of the gauze according to claim 10 in an installation for the catalytic oxidation of ammonia into NO.

12. Installation for the catalytic oxidation of ammonia to NO, comprising at least one catalyst gauze according to claim 10.

13. Wire according to claim 3, wherein 0.010 mm≤d_{f}≤0.070 mm.

14. Wire according to claim 3, wherein 0.010 mm≤d_{f}≤0.065 mm.
